(19) United States
(12) Patent Application Publication
(10) Pub. No.: US 2007/0216061 A1
(43) Pub. Date: Sep. 20, 2007

(54) Method Of Producing A Silicone Rubber Item And The Product Obtainable By The Method

(75) Inventors: Joachim Karthauser, Sollentuna (SE); Maike Benter, Roskilde (DK); Martin Alm, Greve (DK)

Correspondence Address: BUCHANAN, INGERSOLL & ROONEY PC, POST OFFICE BOX 1404, ALEXANDRIA, VA, 22313-1404, US

(73) Assignee: NANON A/S, Brondby (DK)

(21) Appl. No.: 11/688,907

(22) Filed: Mar. 21, 2007

Related U.S. Application Data
(63) Continuation-in-part of application No. PCT/DK05/50006, filed on Oct. 25, 2005.

(30) Foreign Application Priority Data
Oct. 25, 2004 (DK) PA 2004 01632

(51) Int. Cl. B29C 71/00; C08J 5/00; C08G 77/00

(52) U.S. Cl. 264/236; 264/237; 264/331.11; 528/10

(57) ABSTRACT

A method of producing a silicone rubber item. The method includes the steps of i) shaping the silicone rubber item and ii) subjecting the shaped item to a cold curing, wherein the cold curing includes feeding the shaped item into a reactor, and subjecting the shaped item to an extraction treatment using carbon dioxide containing solvent at a pressure between 10 and 50 bars, wherein the item has an initial temperature below 60° C. in the extraction step, and in at least a part of the extraction time the item has a temperature below 25° C. and a pressure so that the carbon dioxide is in its liquid state. The reactor may preferably be rotated during the cold curing

### CROSS-REFERENCE TO RELATED APPLICATIONS

The present application is a continuation-in-part of PCT/DK2005/050006, filed on Oct. 25, 2005, and which designated the US. The entire contents of PCT/DK2005/050006 is incorporated herein by reference.

### BACKGROUND OF THE INVENTION

The present invention relates to a method of producing a silicone rubber item, such as a medical item or other silicone items where high quality is desired.

Silicone rubber has been used in a variety of fields as medical instruments, building materials, electric and electronic parts, automotive parts, and business machine parts because of its superior properties including physiological inertness (non-toxicity), weather resistance, durability, release properties, and heat resistance.

Silicone rubber item may today be produced in many ways using various starting materials and tempering systems. U.S. Pat. No. 5,519,082 discloses a silicone rubber composition that cures through hydrosilylation. This reaction type is known as the addition tempering type. U.S. Pat. No. 5,973,030 discloses production of liquid silicone rubber compositions. EP 384 609 and U.S. Pat. No. 6,020,449 disclose single-component silicone rubber mixtures (RTV1) which readily cure simply by heating, leading to a very high production yield. Two component silicon rubbers are also very popular.

The methods of producing silicone rubber items in general comprise a step of curing the composition which is most often a process which requires or is speeded up using heat.

After the curing is terminated it has for a lot of applications been found necessary to treat the cured silicone rubber item with heat, for removing undesired and often bad smelling residuals. This heat treatment process can often be very time consuming up to many hours or even days, and requires large production space and heating chambers. Also it is observed that still after prolonged heat treatment the silicone item still has an undesired smell, which often can be put down to catalyst residuals.

In LSR silicon rubber items for example, which are used in medical applications, it has been found essential to subject the items to a post-heat treatment or a post-vulcanization, also referred to as post-curing, in order to reduce the amount of silicon oil residues. The LSR articles have thus been subjected to 2 or even further hours of heat treatment at e.g. at 200° C. under air or oxygen flow.

### DESCRIPTION OF THE INVENTION

The object of the present invention is to provide an improved method for producing a silicone item, in which method the post-heat treatment may be reduced or even eliminated.

The method provided according to the invention has shown to be much faster than the prior art method, and furthermore it will in most circumstances require less working space.

Also it has been found that the method according to the invention may result in a silicone item with a very low amount of undesired residuals both silicone compound residuals, catalyst residuals and other undesired residuals, as compared to silicone item produced using prior art methods.

The inventors of the present invention have thus found than by subjecting the silicone rubber item to a cold curing including extracting the silicone material using a carbon dioxide containing solvent, a much more effective and fast method of producing the silicone rubber item can be provided.

Methods according to the invention are defined in the claims. And as it will be clear from the following description embodiments of the invention provides fur beneficial effects and products. The invention also comprises a silicone rubber item obtainable using the method.

The term ‘silicone rubber item’ is meant to include all items having at least some silicone material. Silicone rubber item thus also includes composites where one of the composite materials is a silicone rubber material, e.g. the composite of a thermoplastic resin bonded to a silicone rubber integrally as described in U.S. Pat. No. 6,800,372 or U.S. Pat. No. 6,613,440. The weight of the silicone rubber item as used in the definitions in this description and claims should, however, include only the weight of the silicone rubber part of the composite material.

The terms “cold curing” and “cold tempering” are used interchangeably.

According to the invention it is preferred that the silicone rubber item should have at least one non-coated surface. This means that at least one surface area of silicone rubber should not be coated with paint or another material directly bonded to the surface (not including packing material, which is to be removed in use).

In one embodiment the silicone rubber item has at least one non-coated surface at least during the cold curing. After the cold curing this non-coated surface may be covered or coated. In one embodiment this non-coated surface remains uncoated except for potential packing material. It has thus been found that the surface of the silicone item produced according to the present invention is very clean and does not exude residual oils which might cause irritation to the body if the silicone item is used against the body e.g. against the skin or mucous membranes.

The silicone item may in principle be any type of items such as tubes, catheters, cable insulations, keypads, gaskets, parts for infant care and feeding (soothers, bottle closures), parts for use in the automotive, telecom and medical sector, films, contact lenses and etc. In particular the method according to one embodiment of the invention is useful for producing silicone rubber items of high quality demands, such as items which should be approved under government regulations e.g. FDA, UBA, Japanese Pharmacopoeia and other relevant regulations concerning material requirements for silicone items designed for medical, implant, direct and indirect food contact and disposable use.

The method of the invention has further been found to be useful in the production of silicone items which heretofore were only produced by casting, due to fragile shapes such as thin material walls e.g. contact lenses and similar items. Since the cold curing is performed effectively at such low temperatures that items with fragile shapes can withstand the extraction treatment without altering shape.

Due to the cold curing performed at low temperatures it has also been found that the extraction of residuals can be performed without any degradation of the material, and the silicone material may maintain its elastically properties, such as hardness and Young's modulus, essentially unchanged.

The method according to the invention may comprise

i) shaping the silicone rubber item and

ii) subjecting the shaped item to a cold curing,

wherein the cold curing comprises feeding the injecting molded item into a reactor, and subjecting the injection molded item to an extraction treatment using carbon dioxide comprising solvent at a pressure between 10 and 50 bars, wherein the item has an initial temperature below 60° C. in the extraction treatment, and in at least a part of the extraction time the item has a temperature below 25° C. and a pressure so that the carbon dioxide is in its liquid state.

The silicone rubber item may be shaped using any method e.g. by blowing, extrusion, molding and combinations thereof.

In one embodiment the method according to the invention comprises the steps of

i) shaping the silicone rubber item by injection molding and

ii) subjecting the injection molded item to a cold curing,

wherein the cold curing includes feeding the injecting molded item into a reactor, and subjecting the injection molded item to an extraction treatment using carbon dioxide containing solvent at a pressure between 10 and 50 bars, wherein the item has an initial temperature below 60° C. in the extraction step, and in at least a part of the extraction time the item has a temperature below 25° C. and a pressure between 10 and 50 bars so that the carbon dioxide is in its liquid state.

In one embodiment the initial temperature is 30° C. or below.

The step of shaping may in one embodiment in addition to extrusion and/or molding comprise other manipulation steps. In one embodiment the shaping step comprises providing the item with a slit or hole extending at least partly through the material of the item. This slit or hole may e.g. be provided during extrusion and/or molding, such as during injection molding or it may in one embodiment be provided after the extrusion and/or molding e.g. using a cutting tool.

When the item is an item with such a slit or hole e.g. a slit or a hole in an infant feeding devise, the method of the invention has the additional benefit that this slit or hole can be provided before the cold curing, because the cold curing is performed under conditions where the silicone item is performed at low temperatures whereby this slit or hole will not collapse or close.

Whereas prior art item with such hole or slit tend to collapse during storing the item treated according to the method of the present invention has shown to be very stable and the risk for collapse of such holes or slits are reduced compared to when using prior art technology.

Also it should be mentioned that if using heat for tempering as in prior art technology, such holes or slits usually collapse and it is necessary to provide the holes/slits after such heat treatment. The present invention has thus shown to provide a major contribution to the art.

In one embodiment the method of producing a silicone rubber item comprises

i) shaping the silicone rubber item and

ii) subjecting the shaped item to a cold curing,

wherein the shaping comprises providing the item with a slit or hole extending at least partly through the material of the item prior to the cold curing, the cold curing being performed at a sufficient low temperature to avoid collapsing or closing of the slit or hold, the cold curing may preferably comprise feeding the shaped item into a reactor, and subjecting the shaped item to an extraction treatment using carbon dioxide comprising solvent, the carbon dioxide being in its liquid state.

It is preferred that the temperature is kept below 60° C., such as below 50° C., such as below 25° C., such as between 5 and 22° C., such as between 8 and 20° C. In one embodiment the temperature during the cold curing is between 8 and 15° C. for the major part of the time.

In particular it is preferred that the temperature during cold curing is kept below about 25° C., because this has shown to give the most optimal extraction, and furthermore the item can be packed directly after the treatment with no need for intermediate cooling. This is both beneficial with respect to production time, but also with respect to the quality of the item as it will be explained further later in the description.

In one embodiment the cold curing step is initiated at a relative high temperature and the item may be transported directly from the injection molding to the cold curing reactor. The initial temperature may be up to 60° C. After the item is placed in the cold curing reactor the temperature is allowed to fall during the cold curing step to terminate the cold curing step at a temperature below 25° C. The temperature fall may be provided by active cooling or by passive cooling.

In one embodiment the cold curing step is initiated at a temperature above 50° C., e.g. around 60° C.

In one embodiment the temperature drops by up to 50° C., such as up to 25° C., such as between 1 and 50° C., such as between 5 and 25° C. during the cold curing step.

In one embodiment the cold curing comprises subjecting the item to an extraction treatment with a carbon dioxide comprising solvent in a pressure reactor, the cold curing comprises extraction with a carbon dioxide at 8-15° C. and 42-50 bars for the major part of the extraction time.

In one embodiment the cold curing comprises subjecting the item to an extraction treatment with a carbon dioxide comprising solvent in a pressure reactor under a pressure of 10 to 50 bars, and a temperature of 0 to 15° C.

In one embodiment the cold curing comprises subjecting the item to an extraction treatment with a carbon dioxide comprising solvent in a pressure reactor under a pressure of 10 to 45 bars and a temperature of 8 to 15° C. in most of the extraction time.

In one embodiment the cold curing comprises subjecting the item to an extraction treatment with a carbon dioxide comprising solvent in a pressure reactor at a temperature below 20° C.

In one embodiment the carbon dioxide containing solvent converts from gas to its liquid state during the cold curing.

In one embodiment the cold curing includes subjecting the silicone rubber item to an extraction treatment with a carbon dioxide containing solvent in a pressure reactor under a pressure of between 5 and 50 bars, and a temperature of between 0 and 60° C.

In one preferred aspect of the invention extraction treatment comprises subjecting the silicone rubber item to an extraction treatment with a carbon dioxide containing solvent in liquid state. Thus, it has surprisingly been found that performing the extraction treatment using the carbon dioxide containing solvent in liquid state is highly effective, even if the pressure is kept relatively low. Thus according to the invention it is preferred that the extraction treatment is performed at a pressure of between 5 and 50 bars, such as between 10 and 50 bars, preferably between 20 and 50 bars, such as between 25 and 50 bars, more preferably between 30 and 50 bars. By using this relatively low pressure, it has surprising been found that the extraction of oil residuals is very effective and very fast compared to using other extraction methods e.g. using supercritical solvents, and simultaneously the requirements to the equipment and in particular the pressure reactor are highly reduced as compared to the cost connected with a pressure reactor for supercritical extraction.

In one embodiment the pressure is kept around 45 bars or below, which in practice has shown to be a sufficient pressure for a fast and effective extraction, in particular when the temperature is kept in the interval 8-15° C. in most of the extraction time.

It is thus in one embodiment it is preferred that the pressure during the entire cold curing step is kept below 45 bars and preferably in the range around 30-35 bars.

In one embodiment the pressure is kept around 45 bars+/−5 bars.

The pressure may be pulsed during the extraction, e.g. such that the pulsed pressure has variations from top to bottom of a pulse of up to 10 bars, such as up to 5 bars, such as up to 2 bars.

The pulsation may speed up the extraction. However, in order to avoid damaging the material the pulsation should not be too fast, since this may result in internal damaging of the silicone rubber material.

In one embodiment the pulsed pressure preferably have a frequency of up to 10 pulses per minutes, such as 2 pulses per minute, wherein one pulse includes decreasing from one pressure top (high pressure peak) to the pressure bottom (low pressure peak) and back to the pressure top.

The extraction treatment may preferably be performed for at least 0.5 minutes, such as at least 1 minute, such as at least 2 minutes, such as at least 4 minutes, such as at least 10 minutes.

The optimal extraction treatment time depends on the type of silicone rubber, including its production method. However, the optimal extraction treatment time depends even more on the shape and thickness of the silicone rubber material.

Test performed on different shapes of silicone rubber items have shown that the optimal extraction treatment time for an item is to subject the silicone rubber item to a treatment with a carbon dioxide containing solvent for at least 0.1 minute per Maximal Shortest Distance to Surface (MSDS) in millimeters. In this connection the term MSDS means the maximal shortest distance to a surface point for any point of material of the item. Preferably the extraction treatment comprises subjecting the item to a treatment with a carbon dioxide containing solvent in liquid state for at least 0.3 minute, such as at least 1.0 minute, such as at least 1.5 minutes, such as at least 2 minutes per MSDS.

In one embodiment the method of the invention comprises the step of subjecting the items to movement during the cold curing. This movement may e.g. be performed by applying a mechanical stirring system inside the chamber or by rotation of the chamber itself (tumbler).

In one embodiment the reaction chamber formed as a tumbler is rotated with a rate of 1-50 Hz (1 Hz=2.4 rpm), such as at a rate of 1-10 Hz during the extraction.

For improving the tumbler effect the inside of the tumbler may in one embodiment comprise protruding elements attached to the walls, also referred to as “wings”. Such wings result in an even more improved effect of extraction due to an improved mixing of the items with the liquid.

In one preferred aspect of the invention the product item is packed. This method thus comprises
shaping the silicone rubber item,
subjecting the shaped item to a cold curing, and
packing the item in a packing material providing a barrier against silicon oil residuals.
   wherein the cold curing comprises feeding the injecting molded item into a reactor, and subjecting the injection molded item to an extraction treatment using carbon dioxide comprising solvent at a pressure between 10 and 50 bars, wherein the item has an initial temperature below 60° C. in the extraction treatment, and in at least a part of the extraction time the item has a temperature below 25° C. and a pressure so that the carbon dioxide is in its liquid state.

The packing material will in general provide a barrier against silicone oil residuals. In other words, silicone oils cannot freely escape from the surface of a packed item as fast as it would have if it had not been packed. Normally, for prior art silicone rubber materials some of the silicone oils migrates through the silicone rubber material and escapes—if the silicone rubber material is not packed—to the environment several months after production e.g. 12 month or even longer, in particular if the silicone rubber material has not been heat treated sufficiently or cold tempered as according to the present invention. This slow migration/evaporation from the silicone rubber material provides the silicone rubber material with an unpleasant smell, and furthermore, if the silicone rubber material is to be used in contact with the human body, this slow migration/evaporation may cause irritation, eczema, bad taste or similar unpleasant effects.

Therefore the method according to the invention is particularly useful for the production of silicone rubber items which are to be packed.

In one embodiment the packing material used in the packing step has a permeability of the silicone oil hexamethylcyclotrisiloxane (D3) of up to 10 g/m²×24 h, such as up to 5 g/m²×24 h, such as up to 1 g/m²×24 h, such as up to 0.1 g/m²×24 h. For some items it is desired that the packing material is impermeable to hexamethylcyclotrisiloxane (D3).

In one embodiment the method of the invention includes packing the silicone rubber item in a packing material with a water vapor permeability (DIN 53122) of up to 100 g/m²×24 h, such as up to 50 g/m²×24 h, such as up to 25 g/m²×24 h, such as up to 10 g/m²×24 h. For some silicone rubber items, it is desired that the moisture levels is kept low and that the item is protected against moisture prior to use. In such situation it is preferred that the packing material has an even lower water vapor permeability e.g. below 1 g/m²×24 h, or even below 1 mg/m²×24 h.

In one embodiment the method of the invention includes packing the silicone rubber item in a packing material which is essentially impermeable to bacteria and viruses. This method is in particular preferably for silicone rubber items for medical use such as catheters, contact lenses and feeding (soothers, bottle closures, tests, dummies) and similar items for use in contact with the human body.

In one embodiment the packing comprises packing the item in a sealed packing material, whereby the packing material provides a barrier against free flow of air. For silicone rubber items for medical use, the sealed packing material may preferably provide a gas-tight package.

In principle the packing in the above method may be performed any time after termination of the cold curing step. But for most productions it is desired that the packing step is performed relatively soon after the cold curing step in order to reduce needs for excessive factory space and space for intermediate storing.

In one embodiment it is therefore desired that the packing step is performed within 60 minutes from termination of the cold curing step, preferably within 40 minutes, such as within 20 minutes, such as within 10 minutes, more preferably within 5 minutes.

If the cold curing step is terminated at elevated temperatures e.g. above 40° C., the silicone rubber item may need to cool down prior to packing. However, if the cold curing step is performed or terminated at temperatures about or below 40° C. it may not be necessary to cool down the silicone rubber item prior to packing. This further has the beneficial effect that the silicone rubber item main be kept very clean or even essentially sterile up to the packing step, and if the packing step is performed under sufficiently clean circumstances the packed product may be very clean. For products for medical use this is a very beneficial effect. Some products, e.g. catheters and contact lenses produced using prior art methods, must be subjected to further sterilization after packing. For similar products produced using the present method this sterilization can be avoided, in particular if the packaging is performed immediately after termination of the cold curing step.

In one embodiment it is thus preferred in one embodiment that the silicone rubber item is packed after the cold curing with no further intermediate treatments, in particular with no additional surface treatments, such as deposition treatments.

In one embodiment the shaped silicone rubber item is mounted with another part e.g. a teat is mounted with a base of another polymer. This mounting may in one embodiment be performed prior to the cold curing step, which means that the cold tempered product may be packed directly after termination of the cold curing step.

In another embodiment the mounting with another part is performed after the cold curing step.

During the cold curing step, carbon dioxide will penetrate into the silicone rubber material. In one embodiment it is desired that the packing step is performed sufficiently shortly after the cold curing step for the item to still comprise releasable carbon dioxide. This carbon dioxide will then be released within the package. The packing step may e.g. be performed sufficiently shortly after the cold curing step for the item to still comprise sufficient carbon dioxide so that the item releases at least 0.01% by weight, such as at least 0.1% by weight or even at least 0.5% of weight of carbon dioxide relative to the weight of the item within the first hour after the package has been sealed.

In situation where the silicone rubber item is only partly cured prior to the cold curing step, the extraction performed during the cold curing step may result in visible area of air bubbles within the material resulting from the removed silicon oil residuals. For some products this may be desired. For other product this may not be desired, and thus a visible test can show if the curing level is sufficiently high, i.e. the amount and size of visible air bubbles is below a desired level or not present at all.

The silicone rubber material for the silicone rubber item may in principle be any type of silicone rubber, in particular polyorganosiloxanes with a backbone consisting of alternating silicon and oxygen atoms.

The silicone rubber may be produced from silicone fluids. Silicone fluids are linear polymers whose chains contain between 2 and well over 1,000 silicon atoms, each of which is linked to the next by an oxygen atom. Unlike mineral oils, silicone fluids change very little in viscosity over a wide temperature range.

In one embodiment the silicone rubber is produced from a precursor silicon mixture comprising one or more silicone components. Preferably the silicone precursor mixture comprises one or more of the silicone components selected from the group consisting of dialkylsilicone elastomers wherein alkyl means hydrocarbon side groups of 1-12 carbon atoms such as methyl, ethyl, hexyl, and octyl; vinyl silicone elastomers; phenyl silicone elastomers; nitrile silicone elastomers; fluorosilicone elastomers, room temperature vulcanising (RTV) silicone elastomers; liquid silicone elastomers (LSR); borosilicone elastomers; the precursor silicon mixture preferably comprises dimethyl silicone elastomers.

In one embodiment the constituents for the precursor mixture comprise long-chain polysiloxanes, catalysts, crosslinking agents and various fillers, such as fumed silica (HDK), quartz, chalk and kaolin, as well as other additives such as pigments, adhesion promoters, and the like.

In one embodiment the silicone item being of silicone rubber selected from RTV-1 silicone rubbers, RTV-2 silicone rubbers and HTV silicone rubbers.

According to the type of useful vulcanization (crosslinking agent and temperature) and the viscosity of the base polymers silicone rubbers may classified as follows:

RTV-1 silicone rubbers are one-component, ready-to-use, room-temperature vulcanizing systems. They may comprise polydimethylsiloxanes, crosslinking agents, fillers, and auxiliaries. After shaping, crosslinking is initiated by contact with atmospheric moisture and proceeds with the elimination of by-products.

RTV-2 silicone rubbers are two-component, pourable, spreadable or kneadable compounds that cure to highly flexible silicone vulcanizates on addition of crosslinking agent.

In one embodiment the silicone rubber material may be made from High Temperature Vulcanizates (HTV)—Liquid silicone rubbers two-component system. As the name suggests, HTV silicone rubbers are vulcanized at high temperatures e.g. during or after injection molding, compression molding or other form of shaping, in the presence of catalyst such as comprises one or more catalyst selected from metal catalysts, organic peroxides and mixtures thereof.

In one embodiment the precursor mixture comprises one or more thermoplasts, the one or more thermoplasts preferably being selected from the group consisting of polyurethane, polyamide and polyolefins.

In one embodiment the precursor mixture comprises one or more catalyst preferably selected from metal catalysts, organic peroxides and mixtures thereof, such as a metal catalyst (e.g. platinum catalyst), and/or organic peroxides such as dibenzoyl, dicumyl and di-tertiary butyl peroxide.

The silicone precursor mixture and accordingly the silicone material may comprise one or more filler material, such as filler materials selected from the group of metals such as, aluminum, tin, lead, magnesium, calcium, strontium, barium, titanium, zirconium, vanadium, chromium, manganese, iron, cobalt, nickel, copper and zinc; metal oxides/hydroxides such as alumina trihydrate, oxides of aluminum, tin, lead, magnesium, calcium, strontium, barium, titanium, zirconium, vanadium, chromium, manganese, iron, cobalt, nickel, copper, antimony and zinc; metal salts, such as phosphates, sulfides, and sulfates; minerals such as spodumene, mica, montmorillonite, kaolinite, bentonite, hectorite, beidellite, attapulgite, chrysolite, garnet, saponite, and hercynite; ceramic materials such as hydrated or anhydrous silicas, silica, silicate glass, quartz, calcium silicates, calcium-magnesium silicates, barium silicates, sodium-alumino-silicates, calcium-alumino-silicates, calcium-sodium-alumino silicates; clays (aluminum silicates) such as halloysite, montmorillonites including sodium and magnesium bentonites; synthetic or natural zeolites; and synthetic or natural talcs (magnesium silicates); and organic materials such as carbon black; graphite, granulated or milled thermoplastics or thermosets such as recycled or virgin polymer resin or rubber; wood-derived materials such as lignin, lignosulfates, Kraft lignin, cellulose and mixtures thereof.

The filler material may in principle have any shape and size e.g. in the form of particles or fibers or mixtures thereof. The filler material may be solid, hollow or porous. Useful fillers are e.g. described in U.S. Pat. No. 4,740,538, U.S. Pat. No. 5,332,429, U.S. Pat. No. 5,968,652, US 2001/00366617, U.S. Pat. No. 5,861,445 and U.S. Pat. No. 4,740,538.

In one embodiment it is preferred that the item is shaped using injection molding. The temperature and the residence time in the molding tool may vary dependent on the material and the shape of the injection molded item. Thicker items normally require longer residence time.

In one embodiment the injection molding is performed with residence times in the molding tool of 10-50 seconds at 150-200° C.

In one embodiment the injection molding is performed with residence times in the molding tool of 30-90 seconds at temperatures between 80 and 150° C.

In one embodiment the injection molding is performed with residence times in the molding tool of more than 60 seconds at temperatures below 80° C.

The injection molded silicone rubber item may in one embodiment be subjected to the cold curing step directly from the injection molding step.

The cold curing step may e.g. be performed batch-wise. In one embodiment the cold curing step is performed batch-wise and this cold curing step is performed physically separately from the shaping machinery. In this embodiment it may be desired that the shaped silicone rubber item is transported from the shaping equipment to a pressure reactor e.g. in a rack adapted to the shape of the silicone rubber items to be treated in the cold curing step. The rack may be adapted to the silicone rubber items so that the major part, such as preferably above 60%, e.g. above 75% or even above 85% of the surface of the silicone rubber items is free of contact while still being supported by the rack.

The carbon dioxide containing solvent may preferably comprise at least 80% by weight, such as at least 85% by weight, such as at least 90% by weight, such as at least 95% by weight, such as at least 99% by weight of carbon dioxide

In one embodiment essentially all of the solvent is constituted by carbon dioxide containing solvent. In one embodiment it is preferred that the carbon dioxide containing solvent comprises at least 1%, such as at least 5% by weight of another composition e.g. a surfactant.

In one embodiment the solvent comprises at least one surfactant selected from the group consisting of perhalogenated and wholly or partly fluorinated surfactants, such as CF₃(CF₂)ₐCH₂ CH₂C(O)OX, a=1-30, polypropylene glycol surfactants, optionally containing up to 75% of weight polyethylene glycol groups, such as HO(CH₂CH(CH₃)O)ᵢ(CH₂ CH₂O)ᵢR, i=1-20 and R=alkyl such as methyl, ethyl, propyl, butyl, or alkyls containing 6-20 carbon atoms such as tetradecyl or hexadecyl, perhaloether surfactants, such as CF₃(CF₂CF₂O)ᵣ(CH₂CH₂O)ₜH, r=1-30 and t=1-40, sorbitan esters, mono- and polyesters of carbonic acid, and polydimethylsiloxane surfactants.

In one embodiment the solvent comprises at least one surfactant selected from the group consisting of poly(1,1′-dihydroperfluorooctyl acrylate)-b-(poly)styrene, poly(1,1′-dihydroperfluorooctyl acrylate-b-styrene), poly(1,1′-dihydroperfluorooctyl acrylate-b-methyl methacrylate), poly(1,1′-dihydroperfluorooctyl acrylate-b-vinyl acetate), poly(1,1′-dihydroperfluorooctyl acrylate-b-vinyl alcohol), poly(1,1′-dihydroperfluorooctyl methacrylate-b-styrene), poly(1,1′-dihydroperfluorooctyl acrylate-co-styrene), poly(1,1′-dihydroperfluorooctyl acrylate-co-vinyl pyrrolidone), poly(1,1′-dihydroperfluorooctyl acrylate-co-2-ethylhexyl acrylate), poly(1,1′-dihydroperfluorooctyl acrylate-co-2-hydroxyethyl acrylate), poly(1,1′-dihydroperfluorooctyl acrylate-co-dimethylaminoethyl acrylate), poly(styrene-g-dimethylsiloxane), poly(methyl acrylate-g-1,1′-dihydroperfluorooctyl methacrylate), poly(1,1′-dihydroperfluorooctyl acrylate-g-styrene), perfluorooctanoic acid, and perfluoro(2-propoxy propanoic) acid.

The amount of surfactant in the carbon dioxide containing solvent may preferably be between 0.001 to 30% by weight, such as between 0.01 and 20% by weight, such as between 0.1 and 5% by weight of one or more surfactants.

In one embodiment the carbon dioxide containing solvent may comprise a co-solvent e.g. a co-solvent selected from the group consisting of methane, ethane, propane, ammonia butane, n-pentane, hexanes, cyclohexane, n-heptane, ethylene, propylene, methanol, ethanol, isopropanol, xylenes, chlorotrifluoromethane, trichlorofluoromethane, perfluoropropane, chlorodifluoromethane, sulfur hexafluoride, nitrous oxide, N-methyl pyrrolidone, acetone, esters of carbonic acid, organosilicones, terpenes, paraffins, and mixtures thereof. The amount of the co-solvent may e.g. be up to about 20% by weight, such as about 15% by weight, such as about 10% by weight, such as about 5% by weight of the carbon dioxide containing solvent.

In the extraction step at least a part of the silicone oil residues in the silicone rubber item is extracted. In particular it is desired to extract the low molecular weight silicone oil residues from the silicone rubber item as it is these low molecular weight silicone oil residues, e.g. compounds with molar weights ranging from about 70 up to 3000 and higher, representing, a.o. D3, D4, D5 a.s.f. and other cyclic or non-cyclic siloxanes, which are migrating out of the silicone rubber material and cause the silicone rubber item to smell and/or to exude undesired components during use.

In one embodiment the cold curing includes subjecting the item to an extraction treatment to thereby remove at least 50% by weight, such as at least 60% by weight, such as at least 70% by weight, such as at least 80% by weight, such as at least 90% by weight, such as at least 95% by weight, such as at least 99% by weight of the extractable residual silicone oils having a molecular weight below 3000.

Extractable residual silicone oils having a molecular weight below 3000 are defined as the residual silicone oils having a molecular weight below 3000 which are extractable using heat. As used herein the extractable residual silicone oil is the oil which is extracted from a silicone rubber item by subjecting it to a heat treatment at 200° C. for 4 hours in a reactor of 1 L volume per 100 g silicone rubber item prior to the treatment and with an air flow through the reactor of 1 L/min per litre reactor volume.

In one embodiment of the invention the cold curing includes subjecting the item to an extraction treatment to thereby remove at least 50% by weight, such as at least 60% by weight, such as at least 70% by weight, such as at least 80% by weight, such as at least 90% by weight, such as at least 95% by weight, such as at least 99% by weight of the extractable residual silicone oils having a molecular weight below 1000, wherein the extractable residual silicone oils having a molecular weight below 1000 are defined as the residual silicone oils having a molecular weight below 1000 which are extractable using heat as disclosed above.

In one embodiment of the invention the cold curing includes subjecting the item to an extraction treatment to thereby remove at least 50% by weight, such as at least 60% by weight, such as at least 70% by weight, such as at least 80% by weight, such as at least 90% by weight, such as at least 95% by weight, such as at least 99% by weight of the extractable residual silicone oils having a molecular weight below 500, wherein the extractable residual silicone oils having a molecular weight below 500 are defined as the residual silicone oils having a molecular weight below 500 which are extractable using heat as disclosed above.

In one embodiment of the invention the cold curing includes subjecting the item to an extraction treatment to thereby remove at least 50% by weight, such as at least 60% by weight, such as at least 70% by weight, such as at least 80% by weight, such as at least 90% by weight, such as at least 95% by weight, such as at least 99% by weight of the extractable residual silicone oils having a molecular weight below 200, wherein the extractable residual silicone oils having a molecular weight below 200 are defined as the residual silicone oils having a molecular weight below 200 which are extractable using heat as disclosed above.

In one embodiment of the invention the cold curing includes subjecting the item to an extraction treatment to thereby remove at least 10% by weight, such as at least 25% by weight, such as at least 40% by weight, such as at least 60% by weight of the weight of those residual silicone oils, irrespective of molecular weight, which can be extracted using Soxleth extraction of the non-extracted silicone item using acetone.

The soxlet extraction should be performed using at least 10 ml acetone per 1 g silicone rubber. The silicone rubber should be scared into small pieces of less than 1 cm³. The extraction time is set to 2 hours followed by a rinse cycle of 20 minutes and a short distillation step. Afterwards the extracts are dried at 50° C. to constant weight. Extracted silicone oils may be subjected to further analysis.

In one embodiment the cold curing includes subjecting the item to an extraction treatment to thereby remove at least 0.05% silicone oil containing residual by weight, such as 0.1% silicone oil containing residual by weight, such as at least 0.2% by weight, such as at least 0.5% by weight silicone oil containing residual by weight of the total item. The silicone oil containing residual also includes a small amount of water.

In one embodiment the cold curing includes subjecting the item to an extraction treatment to thereby remove at least 0.005% by weight of silicone oils having a molecular weight below 3000, such as 0.01% silicone oil by weight, such as at least 0.02% by weight of silicone oils having a molecular weight below 3000 relative to the weight of the total item. The extracted oil may be collected using a cold trap.

In one embodiment the cold curing includes subjecting the item to an extraction treatment to thereby remove at least 0.001% by weight of silicone oils having a molecular weight below 1000, such as 0.005% silicone oil by weight, such as at least 0.01% by weight of silicone oils having a molecular weight below 1000 relative to the weight of the total item.

In one embodiment the cold curing includes subjecting the item to an extraction treatment to thereby remove at least 0.0005% by weight of silicone oils having a molecular weight below 500, such as 0.001% silicone oil by weight, such as at least 0.002% by weight of silicone oils having a molecular weight below 500 relative to the weight of the total item.

In one embodiment the cold curing includes subjecting the item to an extraction treatment to thereby remove at least 0.0001% by weight of silicone oils having a molecular weight below 200, such as 0.0005% silicone oil by weight, such as at least 0.001% by weight of silicone oils having a molecular weight below 200 relative to the weight of the total item.

For silicone rubber items for medical use including catheters, contact lenses and feeding (soothers, bottle closures, tests, dummies) and similar items for use in contact with the human body, it may be desired that the cold curing includes subjecting the item to an extraction treatment to thereby remove a sufficient amount of the low molecular weight residues for meeting government regulations e.g. FDA, UBA, Japanese Pharmacopoeia and other relevant regulations concerning material requirements for silicone items designed for medical, implant, direct and indirect food contact and disposable use. In particular it may be desired that the cold curing includes subjecting the item to an extraction treatment to thereby remove a sufficient amount of the low molecular weight residues for meeting the FDA Regulation 21 CFR 177.2600 as of Apr. 1, 2004.

In one embodiment the cold curing comprises subjecting the item to an extraction treatment to thereby remove a sufficiently amount of the low molecular weight residues for meeting at least one of the FDA Regulation 21 CFR 177.2600 as of Apr. 1, 2004, the EN standards EN 14350/2 as of August 2004 and the EN standards EN 1400 as of 1, Sep. 2002.

In one embodiment of the invention the silicone item is packed prior to being subjected to cold curing. It has thus been found that the extraction of residuals may be performed through the packing material. Thereby the item may be kept free of contamination during loading an unloading of the reactor and simultaneously a very simple handling of the items may be provided.

In one embodiment of the invention the method thus comprises
shaping the silicone rubber item,
packing the item in a packing material and
subjecting the shaped item to a cold curing,
   wherein the shaped item being packed prior to the cold curing, the cold curing comprises subjecting the shaped item to an extraction treatment using carbon dioxide comprising solvent, and the carbon dioxide being in its liquid state. The method may comprise packing the item in a sealed packing material prior to cold curing.

The packing material used in this embodiment where the item is packed prior to cold curing should preferably be permeable to carbon dioxide in liquid state, such as in the liquid state under the condition of the cold curing.

The packing material may however, preferably be essentially impermeable to bacteria and viruses at 1 bar and 20° C.

In one embodiment the packing material is selected from the group consisting of woven or non woven materials, e.g. Aramid, Kevlar, Polyimid, Polyesters, Polyacrylates, Paper, Cotton, Linnen, PE, PP, PA, PPS, PBT. The packing material may e.g. be in the form of foil.

The packing may in one embodiment be essentially non-permeable to bacteria and other microorganism. The item may thus be kept in an essentially sterilized state. Since the cold curing also may have a sterilizing effect on the item the method may thus be used for reducing microorganism on the surface of the item even when the item is packed prior to the treatment, and the packing material may thus prevent further undesired contamination.

In one embodiment the packing material has a thickness of 1 μm to 500 μm such as of at least 5 μm, such as of at least 20 μm, such as of between 25 and 200 μm.

Even when the cold curing is performed after packing one or more catalyst selected from metal catalysts, organic peroxides and mixtures thereof may be extracted if the silicon rubber item is made from a precursor silicon mixture comprising such catalyst. Thereby undesired smell can be extracted through the packing material

In one embodiment the cold curing comprises subjecting the item to an extraction treatment to thereby remove at least 10% by weight of residuals, irrespective of molecular weight, which can be extracted using Soxleth extraction of the non-extracted silicone item using acetone.

In one embodiment the cold curing comprises the cold curing comprises subjecting the item to an extraction treatment to thereby remove at least 0.05% silicone oil by weight of the total item e.g. through a packing material.

In one embodiment the cold curing comprises subjecting the item to an extraction treatment to thereby remove at least 0.1% residuals by weight of the total item e.g. through a packing material.

According to the invention it has been found that also other residuals in the silicone item may be extracted during the cold curing. In particular it has been found that the cold curing may result in removing of undesired smells.

In one embodiment the method of producing a silicone rubber item comprises

i) shaping the silicone rubber item from a material comprising one or more catalyst selected from metal catalysts, organic peroxides and mixtures thereof,

ii) subjecting the shaped item to a cold curing for removal of at least a part of said catalyst.

Preferably at least 1% by weight, such as at least 5% by weight, such at 10% by weight, such as 20% by weight of the catalyst in the item is extracted in the cold curing.

In one embodiment the cold curing comprises subjecting the item to an extraction treatment to thereby remove at least 0.1% residuals by weight of the total item. The term ‘residuals’ includes all material removed during cold curing.

During the cold curing it has in one embodiment been found that by introducing additional gas which may e.g. be inert or it may be reactive, the extraction time may be reduced. Thus, in one embodiment it is desired that the cold curing includes subjecting the item to an extraction treatment wherein a gas is introduced into the reactor during the extraction treatment, where it is released to thereby create a pressure gradient from the bulk of the item to the surrounding solvent, thereby creating a flow of solutes from the item to the solvent. The gas may e.g. be nitrogen, oxygen or Helium. The amount of gas may preferably be at least 0.1 mol, such as at least 0.5 mol, such as at least 1 mol gas per litre reactor volume.

The extraction effect during the extraction treatment may further be increased by providing turbulence within the reactor e.g. by stirring or preferably by rotation and/or shaking the pressure reactor.

When performing the cold curing it has also been observed that the pressure and temperatures during the cold curing may be regulated so that the cold curing includes removal of particles such as dust and silicone dioxide, and removal of any mould release agents and lubricating chemicals used during extrusion or molding or shaping, combined with the process of cold curing.

In one embodiment the method of producing a silicone rubber item comprises

i) shaping the silicone rubber item and

ii) subjecting the shaped item to a cold curing for removal of impurities selected from particles, mould release agents and lubricating chemicals.

In one embodiment the cold curing includes deposition and optional cross-linking of materials and substances within the silicone rubber item, such materials and substances selected from the group of pigments and dyes, as well as organic monomers and suitable cross-linking agents and radical starters such as olefins such as ethylene and propylene and butadiene, vinyl compounds such as vinyl acetate, vinyl-pyrrolidinone, styrene, acrylic compounds, epoxides such as propylene oxide and diglycidylethers, urethane precursors such as glycols and diisocyanates.

Further information concerning deposition and optional cross-linking within the silicone rubber material of the silicone rubber item can be found in WO 03068846 and PA 2003 01027 (PCTDK04000476).

In one embodiment the cold curing step comprises partial removal or chemical derivatisation of one or more of the compounds selected from the group consisting of organic peroxides, decomposition products of organic peroxides, platinum catalyst or ligands of platinum catalysts, unreacted silanes, cross-linkers and silanols of molecular weights below 3000. Chemical derivatisation is understood to be addition of chemical groups, i.e. one or more chemical groups are bonded to one or more of the compounds selected from the group consisting of organic peroxides, decomposition products of organic peroxides, platinum catalyst or ligands of platinum catalysts, unreacted silanes, cross-linkers and silanols of molecular weights below 3000. The one or more chemical groups will typically be decomposition product from one or more components within the silicone rubber material.

The invention also relates to the silicone rubber item obtainable by the method of the invention. In particular the invention relates to silicone rubber items selected from the group consisting of extruded products: tubes, catheters, cable insulations, injection molded products: keypads, gaskets, parts for infant care and feeding (soothers, bottle closures), parts for use in the automotive, telecom and medical sector, films and contact lenses.

In one embodiment the item has at least one non-coated surface adapted to be brought into contact with the human or animal body, said item preferably being selected from the group consisting of catheters, parts for infant care and feeding (soothers, bottle closures) and contact lenses.

In one embodiment the silicone rubber item obtained by the method of the invention comprises a lower amount by weight of residuals than it would have had without the cold curing.

In one embodiment the silicone rubber item obtained by the method of the invention comprises a lower amount by weight of impurities than it would have had without the cold curing.

In one embodiment the silicone rubber item obtained by the method of the invention is essentially free of smell caused by residual catalyst.

### EXAMPLES

### Example 1

Injection molded silicone rubber plates of 1, 2 and 3 mm thickness (other dimensions 15 cm*4 cm) were used as standard in cold curing step experiments. The raw materials were 2 component (A and B) LSR (liquid silicone rubber), e.g. available from Wacker under the tradename Elastosil, furthermore peroxide-vulcanised silicone rubber was studied.

Hardnesses of all rubbers investigated ranged from 90 Shore A, 70 Shore A, 50 Shore A, 20 Shore A and 10 Shore A.

The extraction parameters were as follows: items were placed in a 10 litre reactor, liquid CO₂ was added, and extraction proceeded under stirring of CO₂, rotation of the holding device in which the rubber items were placed, or rotation of the complete reactor, for 5, 10, 15 or 40 minutes at 8-15° C. and a pressure of 30-45 bars. The pressure could be varied during the extraction by adding other gases such as nitrogen, oxygen or helium. The extraction was terminated by transferring the liquid from the reactor to a distillation tank or to atmosphere. The residual pressure was decreased at varying rates, such as 40 bar/minute or as low as 2 bar/minute.

Observations:

The rate of decompression was found to be critical for the mechanical integrity of rubbers with hardnesses below 40 Shore A and in particular for rubbers below 10-20 Shore A. All rubber items (which typically are opaque or transparent) are at least partly white, presumably because CO₂ has swollen the interstitial volumes within the bulk polymer. With decay times of typically minutes the items resume their original color, and a clear correlation is found with the weight loss (in the order of 1-3% of the weight of the polymer), i.e. gas migrating out of the polymer into atmosphere. Most polymer items show in addition to the white color “bubbles” (ca. 1 mm size) which disappear completely from harder rubbers but may persist in the case of rubbers softer than 20 Shore A. Furthermore, mechanical delamination occurs in soft rubbers, especially in thicker parts and especially if the rate of decompression is faster than 10 bar/minute.

Upon equilibration (i.e. weight constant after gas evaporation), the rubber items have lost 0.2-1.8% weight whereby the weight loss is clearly related to extraction time and thickness of the polymer. The weight loss is related to the absolute amount of silicone oils which can be measured in control experiments using Soxleth extraction of rubber using acetone or methylethylketone (MEK) as solvents. Typically, 75% of the absolute amount of oil as measured by Soxleth extraction is extracted using liquid CO₂ within 20 minutes of extraction. Furthermore, rotation speed, pressure pulsing, surfactant addition, CO₂ cycling (removal, distillation, replacement) etc. affect the rate of extraction.

Mechanical properties were, in general, only marginally affected by extraction. Elongation at break, tensile strength, modulus, compression set, permanent deformation upon elongation and the like were not changed within experimental error. A 3-10% increase in oxygen permeability was found for extracted silicone versus non-extracted silicone.

### Example 2

Plates as used in example 1 but made of peroxide-vulcanised silicone were extracted according to procedures described above and simultaneously impregnated using blue pigments, such as Victoria B or phtalocyanin based pigments. The purpose of the experiment was partly to extract compounds which cause yellow color directly and which increase the rate of yellowing upon ageing. As result, the intensity of the yellow color is reduced by direct extraction, the yellowing by ageing is slowed down, and the impregnation of blue pigments is found useful for compensating the yellow color. The weight increase by pigment addition is too low to be measurable.

### Example 3

Analysis of silicone rubber samples after CO₂-extraction by acetone-extraction (soxleth). In CO₂-extraction it is not simple to collect the extracted low molecular silicone oils and it may be simpler to calculate the amount of removed residues by weighing the samples. To get more specific values we extracted the CO₂-cured samples in acetone in a Büchi Universal Extraction Unit B811 and calculated the amount of extractable silicon oils from the weight of the extract.

150 ml acetone per sample (Fischer Chemicals, 0.042% water) was used. The samples were scared into small pieces and there was used 1.5 to 6 g of the sample for analysis. Repeat determinations were made. The extraction time is about 2 hours followed by a rinse cycle of 20 minutes and a short distillation step. Afterwards the extracts were dried for 2 hours at 50° C. and weighed. The amount of CO₂ extracted silicone oils is calculated from the difference between the amount of silicone oils extracted from untreated samples and the amount from treated samples.

The following samples were analyzed:

| | Original sample, | | |
|---|---|---|---|
| | acetone extract | Post cured in liquid CO₂, acetone | |
| | [wt %] | extract [wt%] | |
| Injection | 1.70 | 0.29 | |
| molded plates | | | |
| (e.g. Wacker | | | |
| elastosil) | | | |
| Baby pacifier/ | 2.57 | 1.53 (20 min CO₂ | 1.13 (2 × 20 min. |
| comforter | extraction) | CO₂ extraction) | |
| (e.g. Avent) | | | |
| Silicone valve | 3.52 | 0.90 | |
| (e.g. Avent) | | | |

Up to 80% of the absolute amount of the low molecular residues is removed in liquid CO₂ extraction.

### Example 4

Large Soothers and Small Pacifiers were Extracted in the Cold Curing Process with the Following Conditions:

All soothers had been proved with a cut before the Cold Curing.

20 to 25 kg of soothers were filled into bags (nylon, 5 kg in each bag), that were filled into the extraction chamber/tumbler. The chamber was closed and pressurized to 42-50 bar, the temperature decreased to 8-15° C. The tumbler was rotating with 3 Hz (7.2 r.p.m). After 15-25 minutes the liquid CO₂ was pumped out of the chamber, distilled, depressurized and leaded back into the chamber that was again pressurized to 42-50 bar. After another 25 minutes tumbling the liquid CO₂ was again removed from the chamber and after depressurizing the chamber was opened and the samples taken out.

Results:

100% of the cuts were still open after the treatment process in liquid CO₂.

The soothers and pacifiers were investigated after the standard EN 14350/2

This standard says, that the volatiles in a soother or pacifier have to be under a amount of 0.5%.

| Volatile weight | | After 1^{st} cycle | After 2^{nd} cycle |
|---|---|---|---|
| loss[%] | Not tempered | (15-25 min) | (40-50 min) |
| Small pacifiers, 25.6 | 0.670 | 0.442 | 0.266 |
| kg (11800 items) | (StD 0.048) | (StD 0.029) | (StD 0.026) |
| Large soothers, 19.2 | 1.036 | 0.606 | 0.400 |
| kg (1600 items) | (StD 0.033) | (StD 0.037) | (StD 0.034) |
| Large soothers, 25 | 0.889 | 0.753 | 0.265 |
| kg (4150 items) | (StD 0.024) | (StD 0.027) | (StD 0.089) |

To shorten the batch time it is also possible to take off the liquid CO₂ after the first cycle without depressurizing the chamber. A variation of the cycle times may be desired as e.g. 1. Cycle 10 minutes, 2. cycle 20 minutes and vs.

### Example 5

Molded silicone items weighing approximately 3 grams were extracted using cold curing, (parameters: Pressure 42-50 bar, temperature 8-15° C., extraction time 35 minutes). Items were split into two groups; one that was put in a commercial sterilisable bag (name: steriking). Both groups were thereafter put inside the same standard PES bag for cold curing treatment, and treated.

Result (volatile content measured according to EN14350-2)—all results % w/w

Reference (untreated): average: 1.14% std. dev. 0.03%

Cold cured—not in streilisable bag: Average: 0.22% std dev 0.01%

Cold cured—inside sterilisable bag: Average: 0.23% std. dev. 0.01%

1. A method of producing a silicone rubber item, said method comprising
i) shaping the silicone rubber item and
ii) subjecting the shaped item to a cold curing,
wherein the cold curing comprises feeding the shaped item into a reactor, and subjecting the shaped item to an extraction treatment using carbon dioxide comprising solvent at a pressure between 10 and 50 bars, wherein the item has an initial temperature below 60° C. in the extraction treatment, and in at least a part of the extraction time the item has a temperature below 25° C. and a pressure so that the carbon dioxide is in its liquid state.

2. A method according to claim 1, wherein said silicone rubber item being shaped by blowing, extrusion, moulding and combinations thereof.

3. A method according to claim 2, wherein said silicone rubber item being shaped by moulding.

4. A method according to claim 3, wherein said silicone rubber item being shaped by injection moulding.

5. A method according to claim 3, wherein said silicone rubber item being shaped by compression moulding.

6. A method according to claim 3, wherein said silicone rubber item being shaped by transfer moulding.

7. A method according to claim 2, wherein said silicone rubber item being shaped by extrusion.

8. A method according to claim 1, wherein the silicone rubber item has at least one non-coated surface at least during the cold curing.

9. A method according to claim 1, wherein the cold curing comprises subjecting the item to a treatment with a carbon dioxide comprising solvent in liquid state for at least 4 minutes.

10. A method according to claim 1, wherein the cold curing comprises subjecting the item to a treatment with a carbon dioxide comprising solvent in liquid state for at least 0.1 minute per Maximal Shortest Distance to Surface (MSDS) in millimetres, wherein the MSDS is the maximal shortest distance to a surface point for any point of material of the item.

11. A method according to claim 1, wherein said silicone rubber being selected from RTV-1 silicone rubbers, RTV-2 silicone rubbers and HTV silicone rubbers.

12. A method according to claim 1, wherein the silicon rubber item is made from a precursor silicon mixture comprising one or more silicone components, preferably said a precursor silicon mixture comprises one or more of the silicone components selected from the group consisting of dialkylsilicone elastomers wherein alkyl means hydrocarbon side groups of 1-12 carbon atoms such as methyl, ethyl, hexyl, and octyl; vinyl silicone elastomers; phenyl silicone elastomers; nitrile silicone elastomers; fluorosilicone elastomers, room temperature vulcanising (RTV) silicone elastomers; liquid silicone elastomers (LSR); borosilicone elastomers; the precursor silicon mixture preferably comprises dimethyl silicone elastomers.

13. A method according to claim 12 wherein the precursor mixture comprises one or more thermoplasts, the one or more thermoplasts.

14. A method according to claim 12 wherein the precursor mixture comprises one or more catalyst selected from metal catalysts, organic peroxides and mixtures thereof.

15. A method according to claim 1, wherein the cold curing is performed batch-wise.

16. A method according to claim 1 wherein the carbon dioxide comprising solvent comprises at least 80% by of carbon dioxide

17. A method according to claim 1 wherein carbon dioxide comprising solvent comprises at least one surfactant.

18. A method according to claim 17 wherein carbon dioxide comprising solvent comprises at least one surfactant, selected from the group consisting of poly(1,1′-dihydroperfluorooctyl acrylate)-b-(poly)styrene, poly(1,1′-dihydroperfluorooctyl acrylate-b-styrene), poly(1,1′-dihydroperfluorooctyl acrylate-b-methyl methacrylate), poly(1,1′-dihydroperfluorooctyl acrylate-b-vinyl acetate), poly(1,1′-dihydroperfluorooctyl acrylate-b-vinyl alcohol), poly(1,1′-dihydroperfluorooctyl methacrylate-b-styrene), poly(1,1′-dihydroperfluorooctyl acrylate-co-styrene), poly(1,1′-dihydroperfluorooctyl acrylate-co-vinyl pyrrolidone), poly(1,1′-dihydroperfluorooctyl acrylate-co-2-ethylhexyl acrylate), poly(1,1′-dihydroperfluorooctyl acrylate-co-2-hydroxyethyl acrylate), poly(1,1′-dihydroperfluorooctyl acrylate-co-dimethylaminoethyl acrylate), poly(styrene-g-dimethylsiloxane), poly(methyl acrylate-g-1,1′-dihydroperfluorooctyl methacrylate), poly(1,1′-dihydroperfluorooctyl acrylate-g-styrene), perfluorooctanoic acid, perfluoro(2-propoxy propanoic) acid and mixtures thereof.

19. A method according to claim 1 wherein the carbon dioxide comprising solvent comprises a co-solvent.

20. A method according to claim 1 wherein the cold curing comprises subjecting the item to an extraction treatment with a carbon dioxide comprising solvent in a pressure reactor, the cold curing comprises extraction with a carbon dioxide at 8-15° C. and 42-50 bars for the major part of the extraction time.

21. A method according to claim 1 wherein the cold curing comprises subjecting the item to an extraction treatment with a carbon dioxide comprising solvent in a pressure reactor under a pressure of 10 to 50 bars, and a temperature of 0 to 15° C.

22. A method according to claim 1 wherein the cold curing comprises subjecting the item to an extraction treatment with a carbon dioxide comprising solvent in a pressure reactor under a pressure of 10 to 45 bar and a temperature of 8 to 15° C. in most of the extraction time.

23. A method according to claim 1 claims wherein the cold curing comprises subjecting the item to an extraction treatment with a carbon dioxide comprising solvent in a pressure reactor at a temperature below 20° C.

24. A method according to claim 1 wherein the cold curing comprises subjecting the item to an extraction treatment with a carbon dioxide comprising solvent in a pressure reactor wherein the pressure is pulsed.

25. A method according to claim 24 wherein the cold curing comprises subjecting the item to an extraction treatment with a carbon dioxide comprising solvent in a pressure reactor wherein the pressure is pulsed with a frequency of up to 10 pulses per minutes.

26. A method according to claim 1 wherein the cold curing comprises subjecting the item to an extraction treatment to thereby remove at least 10% by weight of those residual silicone oils, irrespective of molecular weight, which can be extracted using Soxleth extraction of the non-extracted silicone item using acetone.

27. A method according to claim 1 wherein the cold curing comprises subjecting the item to an extraction treatment to thereby remove at least 0.05% silicone oil by weight of the total item.

28. A method according to claim 1 wherein the cold curing comprises subjecting the item to an extraction treatment to thereby remove at least 0.1% residuals by weight of the total item.

29. A method according to claim 1 wherein the cold curing comprises subjecting the item to an extraction treatment to thereby remove at least 0.005% by weight of silicone oils having a molecular weight below 3000 relative to the weight of the total item.

30. A method according to claim 1 wherein the cold curing comprises subjecting the item to an extraction treatment to thereby remove at least 0.001% by weight of silicone oils having a molecular weight below 1000 relative to the weight of the total item.

31. A method according to claim 1 wherein the cold curing comprises subjecting the item to an extraction treatment to thereby remove at least 0.0005% by weight of silicone oils having a molecular weight below 500 relative to the weight of the total item.

32. A method according to claim 1 wherein the cold curing comprises subjecting the item to an extraction treatment to thereby remove at least 0.0001% by weight of silicone oils having a molecular weight below 200 relative to the weight of the total item.

33. A method according to claim 1 wherein the cold curing comprises subjecting the item to an extraction treatment to thereby remove a sufficiently amount of the low molecular weight residues for meeting at least one of the FDA Regulation 21 CFR 177.2600 as of Apr. 1, 2004, the EN standards EN 14350/2 as of August 2004 and the EN standards EN 1400 as of 1, Sep. 2002.

34. A method according to claim 1 wherein the cold curing comprises subjecting the item to an extraction treatment wherein a gas is introduced into the reactor during the extraction treatment, where it is released to thereby create a pressure gradient from the bulk of the item to the surrounding solvent, thereby creating a flow of solutes from the item to the solvent.

35. A method according to claim 1, wherein the cold curing comprises deposition and optional cross-linking of materials and substances within the silicone rubber item.

36. A method according to claim 1, wherein the cold curing comprises partial removal or chemical derivatisation of one or more of the compounds selected from the group consisting of organic peroxides, decomposition products of organic peroxides, platinum catalyst or ligands of platinum catalysts, unreacted silanes, cross-linkers and silanols of molecular weights below 3000, whereby chemical derivatisation is understood to be addition of chemical groups.

37. A method according to claim 1, wherein the cold curing comprises rotating of the reactor with a rate of 1-50 Hz during the extraction.

38. A method of producing a silicone rubber item, said method comprising
i) shaping the silicone rubber item and
ii) subjecting the shaped item to a cold curing,
wherein the shaping comprises providing the item with a slit or hole extending at least partly through the material of the item prior to the cold curing, the cold curing being performed at a sufficient low temperature to avoid collapsing or closing of the slit or hold.

39. A method according to claim 38 wherein the cold curing comprises feeding the shaped item into a reactor, and subjecting the shaped item to an extraction treatment using carbon dioxide comprising solvent, the carbon dioxide being in its liquid state.

40. A method according to claim 38 wherein the cold curing being performed at a pressure between 10 and 50 bars.

41. A method according to claim 39 wherein the cold curing the item has an initial temperature below 60° C. in the extraction treatment, and in at least a part of the extraction time the item has a temperature below 25° C. and a pressure so that the carbon dioxide is in its liquid state.

42. A method according to claim 38, wherein said silicone rubber item being shaped by blowing, extrusion, moulding and combinations thereof.

43. A method according to claim 38, wherein the cold curing comprises subjecting the item to a treatment with a carbon dioxide comprising solvent in liquid state for at least 4 minutes.

44. A method according to claim 38, wherein said silicone rubber being selected from RTV-1 silicone rubbers, RTV-2 silicone rubbers and HTV silicone rubbers.

45. A method according to claim 38 wherein the cold curing comprises subjecting the item to an extraction treatment with a carbon dioxide comprising solvent in a pressure reactor under a pressure of 10 to 50 bars, and a temperature of 0 to 15° C.

46. A method according to claim 38 claims wherein the cold curing comprises subjecting the item to an extraction treatment with a carbon dioxide comprising solvent in a pressure reactor at a temperature below 20° C.

47. A method according to claim 38 wherein the cold curing comprises subjecting the item to an extraction treatment to thereby remove at least 10% by weight of those residuals, irrespective of molecular weight, which can be extracted using Soxleth extraction of the non-extracted silicone item using acetone.

48. A method of producing a silicone rubber item, said method comprises
shaping the silicone rubber item,
subjecting the shaped item to a cold curing, and
packing the item in a packing material providing a barrier against silicon oil residuals.
wherein the cold curing comprises feeding the injecting moulded item into a reactor, and subjecting the injection moulded item to an extraction treatment using carbon dioxide comprising solvent at a pressure between 10 and 50 bars, wherein the item has an initial temperature below 60° C. in the extraction treatment, and in at least a part of the extraction time the item has a temperature below 25° C. and a pressure so that the carbon dioxide is in its liquid state.

49. A method according to claim 48, wherein the packing material has a water vapour permeability (DIN 53122) of up to 100 g/m²×24 h, such as up to 50 g/m²×24 h, such as up to 25 g/m²×24 h, such as up to 10 g/m²×24 h.

50. A method according to claim 48, wherein the packing material has a permeability of the silicone oil hexamethylcyclotrisiloxane (D3) of up to 10 g/m²×24 h, such as up to 5 g/m²×24 h, such as up to 1 g/m²×24 h, such as up to 0.1 g/m²×24 h.

51. A method according to claim 48, wherein the packing material is essentially impermeable to bacteria and viruses.

52. A method according to claim 48, wherein the packing comprises packing the item in a sealed packing material, whereby the packing material provides a barrier against free flow of air, preferably the sealed packing material provides a gas-tight package.

53. A method according to claim 48, wherein the packing is performed within 60 minutes from termination of the cold curing.

54. A method according to claim 48, wherein the packing is performed sufficiently shortly after the cold curing for the item to still comprise releasable carbon dioxide which will be released within the package

55. A method according to claim 54, wherein the item releases at least 0.01% by weight, such as at least 0.1% by weight or even at least 0.5% of weight of carbon dioxide relative to the weight of the item within the first hour after the package has been sealed.

56. A method according to claim 48, wherein the packing is performed after the cold curing with no additional surface treatments.

57. A method according to claim 48, wherein said silicone rubber item being shaped by blowing, extrusion, moulding and combinations thereof.

58. A method according to claim 48, wherein said silicone rubber being selected from RTV-1 silicone rubbers, RTV-2 silicone rubbers and HTV silicone rubbers.

59. A method according to claim 48, wherein the silicon rubber item is made from a precursor silicon mixture comprising one or more silicone components and one or more catalyst selected from metal catalysts, organic peroxides and mixtures thereof.

60. A method according to claim 48 wherein the cold curing comprises subjecting the item to an extraction treatment to thereby remove at least 10% by weight of residuals, irrespective of molecular weight, which can be extracted using Soxleth extraction of the non-extracted silicone item using acetone.

61. A method according to claim 48 wherein the cold curing comprises subjecting the item to an extraction treatment to thereby remove at least 0.05% silicone oil by weight of the total item.

62. A method according to claim 48 wherein the cold curing comprises subjecting the item to an extraction treatment to thereby remove at least 0.1% residuals by weight of the total item.

63. A method according to claim 48, wherein the cold curing comprises partial removal or chemical derivatisation of one or more of the compounds selected from the group consisting of organic peroxides, decomposition products of organic peroxides, platinum catalyst or ligands of platinum catalysts, unreacted silanes, cross-linkers and silanols of molecular weights below 3000, whereby chemical derivatisation is understood to be addition of chemical groups.

64. A method of producing a silicone rubber item, said method comprises
shaping the silicone rubber item,
packing the item in a packing material and
subjecting the shaped item to a cold curing,
wherein the shaped item being packed prior to the cold curing, the cold curing comprises subjecting the shaped item to an extraction treatment using carbon dioxide comprising solvent, and the carbon dioxide being in its liquid state.

65. A method according to claim 64 wherein the cold curing being performed at a pressure between 10 and 50 bars.

66. A method according to claim 64 wherein the cold curing the item has an initial temperature below 60° C. in the extraction treatment, and in at least a part of the extraction time the item has a temperature below 25° C. and a pressure so that the carbon dioxide is in its liquid state.

67. A method according to claim 64, wherein said silicone rubber item being shaped by blowing, extrusion, moulding and combinations thereof.

68. A method according to claim 64, wherein the cold curing comprises subjecting the item to a treatment with a carbon dioxide comprising solvent in liquid state for at least 4 minutes.

69. A method according to claim 64, wherein said silicone rubber being selected from RTV-1 silicone rubbers, RTV-2 silicone rubbers and HTV silicone rubbers.

70. A method according to claim 64, wherein the packing material being permeable to carbon dioxide in liquid state.

71. A method according to claim 70, wherein the packing material being permeable to carbon dioxide in liquid state at a pressure from 10-50 bars and a temperature below 25° C.

72. A method according to claim 64, wherein the packing material is essentially impermeable to bacteria and viruses at 1 bar and 20° C.

73. A method according to claim 64, wherein the packing comprises packing the item in a sealed packing material.

74. A method according to claim 64, wherein the packing material is selected from the group consisting of Aramid, Kevlar, Polyimid, Polyesters, Polyacrylates, Paper, Cotton, Linnen, PE, PP, PA, PPS, PBT, and mixtures thereof.

75. A method according to claim 64, wherein the packing material has a thickness of 1 μm to 500 μm such as of at least 5 μm, such as of at least 20 μm, such as of between 25 and 200 μm.

76. A method according to claim 64, wherein the silicon rubber item is made from a precursor silicon mixture comprising one or more silicone components and one or more catalyst selected from metal catalysts, organic peroxides and mixtures thereof.

77. A method according to claim 64 wherein the cold curing comprises subjecting the item to an extraction treatment to thereby remove at least 10% by weight of residuals, irrespective of molecular weight, which can be extracted using Soxleth extraction of the non-extracted silicone item using acetone.

78. A method according to claim 64 wherein the cold curing comprises subjecting the item to an extraction treatment to thereby remove at least 0.05% silicone oil by weight of the total item.

79. A method according to claim 64 wherein the cold curing comprises subjecting the item to an extraction treatment to thereby remove at least 0.1% residuals by weight of the total item.

80. A method according to claim 64 wherein the shaping comprises providing the item with a slit or hole extending at least partly through the material of the item prior to the cold curing, the cold curing being performed at a sufficient low temperature to avoid collapsing or closing of the slit or hold.

81. A method of producing a silicone rubber item, said method comprising
i) shaping the silicone rubber item and
ii) subjecting the shaped item to a cold curing for removal of impurities selected from particles, mould release agents and lubricating chemicals,
wherein the cold curing comprises feeding the injecting moulded item into a reactor, and subjecting the injection moulded item to an extraction treatment using carbon dioxide comprising solvent at a pressure between 10 and 50 bars, wherein the item has an initial temperature below 60° C. in the extraction treatment, and in at least a part of the extraction time the item has a temperature below 25° C. and a pressure so that the carbon dioxide is in its liquid state.

82. A method of producing a silicone rubber item, said method comprising
i) shaping the silicone rubber item from a material comprising one or more catalyst selected from metal catalysts, organic peroxides and mixtures thereof,
ii) subjecting the shaped item to a cold curing for removal of at least a part of said catalyst,
wherein the cold curing comprises feeding the injecting moulded item into a reactor, and subjecting the injection moulded item to an extraction treatment using carbon dioxide comprising solvent at a pressure between 10 and 50 bars, wherein the item has an initial temperature below 60° C. in the extraction treatment, and in at least a part of the extraction time the item has a temperature below 25° C. and a pressure so that the carbon dioxide is in its liquid state.

83. A method according to claim 82 wherein at least 10% of the catalyst being extracted in the cold curing.

84. A silicone rubber item obtained by the method according to 1, the silicone rubber item comprises a lower amount of residuals than it would have had without the cold curing.

85. A silicone rubber item obtained by the method according to 38, the silicone rubber item comprises a lower amount of residuals than it would have had without the cold curing.

86. A silicone rubber item obtained by the method according to 48, the silicone rubber item comprises a lower amount of residuals than it would have had without the cold curing.

87. A silicone rubber item obtained by the method according to 64, the silicone rubber item comprises a lower amount of residuals than it would have had without the cold curing.

88. A silicone rubber item obtained by the method according to 1, the silicone rubber item comprises less impurities than it would have had without the cold curing.

89. A silicone rubber item obtained by the method according to 1, the silicone rubber item is essentially free of smell caused by evaporating catalyst.

90. A silicone rubber item according to claim 84 wherein the item is selected from the group consisting of extruded products: tubes, catheters, cable insulations, injection moulded products: keypads, gaskets, parts for infant care and feeding (soothers, bottle closures), parts for use in the automotive, telecom and medical sector, films and contact lenses.

91. A silicone rubber item according to claim 84, wherein the item has at least one non-coated surface adapted to be brought into contact with the human or animal body, said item preferably being selected from the group consisting of catheters, parts for infant care and feeding (soothers, bottle closures) and contact lenses.
